(19) United States
(12) Patent Application Publication
(10) Pub. No.: US 2014/0380046 A1
(43) Pub. Date: Dec. 25, 2014

(54) COLLABORATIVE STREAMING SYSTEM FOR PROTECTED MEDIA

(71) Applicants: Rajesh Poornachandran, Portland, OR (US); Yeugeniy Epshteyn, Portland, OR (US); Michael D. Rosenzweig, Hopkinton, MA (US); Abhijeet Kolekar, Hillsboro, OR (US); Niveditha Sundaram, Hillsboro, OR (US); Ajit P. Joshi, Portland, OR (US); Junhai Qiu, Hillsboro, OR (US)

(72) Inventors: Rajesh Poornachandran, Portland, OR (US); Yeugeniy Epshteyn, Portland, OR (US); Michael D. Rosenzweig, Hopkinton, MA (US); Abhijeet Kolekar, Hillsboro, OR (US); Niveditha Sundaram, Hillsboro, OR (US); Ajit P. Joshi, Portland, OR (US); Junhai Qiu, Hillsboro, OR (US)

(21) Appl. No.: 14/126,864

(22) PCT Filed: Jun. 24, 2013
(86) PCT No.: PCT/US2013/047352

§ 371 Date: Dec. 17, 2013

(51) Int. Cl. G06F 21/10; H04L 9/32; H04L 9/06

(52) U.S. Cl. CPC G06F 21/10; H04L 9/06; H04L 9/32
USPC 713/167

(57) ABSTRACT

The present disclosure is directed to a collaborative streaming system for protected media. A presentation device may interact with a group of trusted devices over a network to stream multimedia content. The presentation device may obtain a presentation content encryption key for presenting the content. Each trusted device in a group of trusted devices may obtain a download content encryption key allowing for download without presentation. A leader may be selected for managing the operation of the trusted devices. The leader may determine trusted device condition and assign one or more of the trusted devices to download portions of the content based on the condition. The leader may then consolidate the portions of the content and provide them to the presentation device. If the presentation device is the leader, the presentation device may perform similar operations and collect the portions of the content directly from the group of trusted devices.

### TECHNICAL FIELD

The present disclosure relates to electronic communication, and more particularly, to a system that leverages the communication resources of more than one device for streaming.

### BACKGROUND

The use of electronic communication continues to expand in all aspects of society. Users have long experienced the convenience that mobile handsets can provide in terms of telephonic communication, and the advent of smart phones including the ability to transmit and receive data wirelessly has only fueled the desire for expanded functionality. Devices available in the market today may now provide email connectivity, messaging, navigation and a variety of application-based operations based on wireless communication. One area where applications may rely heavily on electronic communication is during “streaming”. In streaming, information may be received continuously in a device to generate uninterrupted presentation of multimedia (e.g., audio, video, textual, etc.) content. For example, content such as music, television program, movies. etc. may be streamed to mobile devices so that user may be able to enjoy this content whenever they have a device and a wireless signal.

However, the growth in the use of streaming, at least in mobile devices, may be based on the experience being both enjoyable for users and secure for content owners. The ability to present streamed content in mobile devices may not be attractive to users unless the quality is the same as, or at least close to, the quality experienced when the content is presented on a device with a wired connection. Further to the capability of the presentation device, the rate at which content is received has a substantial effect on the presentation quality. If streamed content is received too slowly, the presentation of the content may pause, jump, pixelate, etc. To counter this issue, some devices may automatically reduce the presentation quality (e.g., audio bitrate, video resolution, etc.) so that less data is needed to maintain continuity during presentation. However, a noticeable reduction in presentation quality may negatively impact user experience. In addition, content providers want to be able to maintain control over the devices that are streaming their content. Allowing content to be streamed in an uncontrolled manner may impact revenue for content providers (e.g., allowing nonpaying users to access content), and in turn, may make content providers more hesitant to provide their content for streaming. Not having access to desired content may also negatively impact user experience.

### BRIEF DESCRIPTION OF THE DRAWINGS

Features and advantages of various embodiments of the claimed subject matter will become apparent as the following Detailed Description proceeds, and upon reference to the Drawings, wherein like numerals designate like parts, and in which:

FIG. 1 illustrates an example collaborative streaming system for protected media in accordance with at least one embodiment of the present disclosure;

FIG. 2 illustrates an example configuration for a trusted device usable in a collaborative streaming system for protected media in accordance with at least one embodiment of the present disclosure;

FIG. 3 illustrates an example configuration for a collaborative streaming module in accordance with at least one embodiment of the present disclosure;

FIG. 4 illustrates an example configuration for remote resources in accordance with at least one embodiment of the present disclosure;

FIG. 5 illustrates an example of leader selection in accordance with at least one embodiment of the present disclosure;

FIG. 6 illustrates an example of assigning devices to download content sequentially in accordance with at least one embodiment of the present disclosure;

FIG. 7 illustrates an example of assigning devices to download content concurrently in accordance with at least one embodiment of the present disclosure;

FIG. 8 illustrates example operations from the perspective of a presentation device in accordance with at least one embodiment of the present disclosure; and

FIG. 9 illustrates example operations from the perspective of a leader in accordance with at least one embodiment of the present disclosure.

Although the following Detailed Description will proceed with reference being made to illustrative embodiments, many alternatives, modifications and variations thereof will be apparent to those skilled in the art.

### DETAILED DESCRIPTION

The present disclosure is directed to a collaborative streaming system for protected media. In general, a presentation device may interact with trusted devices over a network to obtain multimedia content for presentation to a user. The presentation device may initially authenticate trusted devices (e.g., devices qualified to stream data for the presentation device) and may form a group of trusted devices. The presentation device may obtain a presentation content encryption key from remote resources (e.g., at least a multimedia content server and a license server) that allows for presentation of the content. Each trusted device in the group of trusted devices may obtain a download content encryption key that allows for download of the content without presentation. A leader may then be selected for managing the operation of the group of trusted devices. If the leader is selected from the group of trusted devices, then the leader may determine the condition of the remaining trusted devices and assign one or more of the trusted devices to download portions of the content based on their condition. The leader may then consolidate the portions of the content and provide them to the presentation device for presentation. Alternatively, if the presentation device is selected as the leader, the presentation device may perform similar operations and collect the portions of the multimedia content directly from the group of trusted devices. The leader may also monitor the operation of trusted devices in the group of trusted devices and reassign the portions of the multimedia content to download if a change is determined to have occurred in the condition of any of the trusted devices. The multimedia content may be encrypted at various stages of conveyance to ensure that only certain devices (e.g., the presentation device) are able to decrypt and then present the content.

In one embodiment a presentation device may comprise, for example, at least a communication module, a collaborative streaming module, a secure processing environment and a user interface module. The communication module may be to communicate via at least one of wired or wireless communication. The collaborative streaming module may be to receive encrypted multimedia content from at least one trusted device in a group of trusted devices via the communication module. The secure processing environment may be to receive the encrypted multimedia content from the collaborative streaming module and to decrypt the encrypted multimedia content based on a first encryption protocol. The user interface module may be to receive the decrypted multimedia content from the secure processing environment and to present the decrypted multimedia content.

The presentation device may further comprise a presentation content encryption key allowing at least decryption of the encrypted multimedia content for presentation by the user interface module. In an example implementation consistent with the present disclosure, the presentation content encryption key may not always reside in the presentation device, and thus, the collaborative streaming module may further be to obtain the presentation content key by authenticating to remote resources. Trusted devices in the group of trusted devices may each comprise a download content encryption key permitting download of the encrypted multimedia content without the ability to decrypt, and thus present, the encrypted multimedia content, the trusted devices obtaining the download encryption key by authenticating to the remote resources. For example, the remote resources may comprise at least a multimedia content server and a license server.

In an example of operation, the collaborative streaming module may be further to determine if trusted devices are in communication range of the presentation device, form the group of trusted devices from the trusted devices determined to be in communication range and select a leader for the group of trusted devices. If a trusted device in the group of trusted devices is selected to be the leader, the collaborative streaming module may be to receive the encrypted multimedia content from the trusted device selected as leader. The leader may be to receive portions of the encrypted multimedia content from at least one other trusted device in the group of trusted devices, consolidate the received portions of encrypted multimedia content and provide the encrypted multimedia content to the presentation device.

If the presentation device is selected as the leader, the collaborative streaming module may be further to receive portions of the encrypted multimedia content from at least one trusted device in the group of trusted devices. In acting as leader, the collaborative streaming module may be further to determine a device condition for each trusted device in the group of trusted devices. The collaborative streaming module may then proceed to assign the portions of the encrypted multimedia content for download to at least one trusted device in the group of trusted devices based on the device condition for each trusted device. The collaborative streaming module may also be to determine changes in device condition for any of the trusted devices and reassign the portions of the encrypted multimedia content for download based on the device condition changes.

In one embodiment, the secure processing environment may be further to encrypt the decrypted multimedia content based on a second encryption protocol. The user interface module may then further be to decrypt the encrypted multimedia content based on the second encryption protocol prior to presenting the decrypted multimedia content. The presentation device may also comprise at least a processing module to determine presentation device condition including at least one of communication status and power level, the processing module being further to cause the collaborative streaming module to receive the encrypted multimedia content from the at least one trusted device in the group of trusted devices based on the determined presentation device condition. A method consistent with at least one embodiment of the present disclosure may include, for example, determining if trusted devices are in communication range of a presentation device, if at least one trusted device is determined to be in communication range, forming a group of trusted devices, selecting a leader of the group of trusted devices, receiving encrypted multimedia content from at least one trusted device in the group of trusted devices, decrypting the encrypted multimedia content based on a first encryption protocol and presenting the decrypted multimedia content.

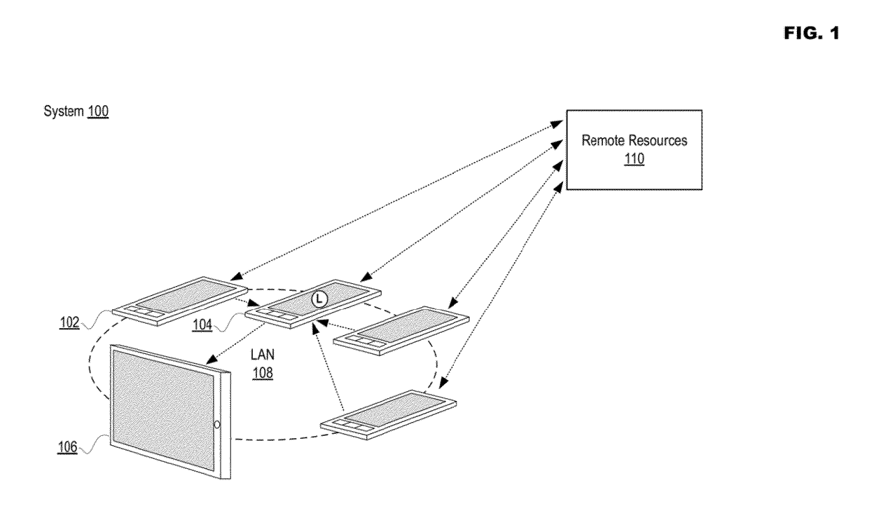

FIG. 1 illustrates an example collaborative streaming system for protected media in accordance with at least one embodiment of the present disclosure. Example system 100 may comprise one or more trusted devices 102, of which one of trusted devices 102 may be leader 104, and presentation device 106 linked by local area network (LAN) 108 using wired and/or wireless communication. Devices 102-106 in LAN 108 may interact with remote resources 110. While system 100 shows leader 104 selected from amongst trusted devices 102, it is also possible for presentation device 106 to act as leader 104. Moreover, the number of devices shown participating in LAN 108 is merely for the sake of explanation, and is not intended implementations consistent with embodiments of the present disclosure to a particular number of devices. The number of devices participating in LAN 108 may vary depending on, for example, the number devices in a particular physical location, the devices in the particular physical location that have been configured for collaborative streaming (e.g., whether the devices in the particular location are trusted), the type of communication being employed to form LAN 108, etc. For example, in instances where wireless communication is being employed in LAN 108, the transmission range of the wireless communication medium would determine the region in which devices may be relied upon for collaborative streaming.

Examples of devices 102, 104 and 106 may include a mobile communication device such as a cellular handset or a smartphone based on the Android® operating system (OS), iOS®, Windows® OS, Blackberry® OS, Palm® OS, Symbian® OS, etc., a mobile computing device such as a tablet computer like an iPad®, Surface®, Galaxy Tab®, Kindle Fire®, etc., an Ultrabook® including a low-power chipset manufactured by Intel Corporation, a netbook, a notebook, a laptop, a palmtop, etc., a stationary computing device such as a desktop computer, a set-top device, a smart television (TV), an audio and/or video electronic conferencing system, etc. In system 100, trusted devices 102 and leader 104 are illustrated as mobile handsets (e.g., smart phones) while presentation device 106 is illustrated as a mobile computing device (e.g. a tablet computer). These example device types are not intended to limit potential implementations to the use of particular device types, and have been chosen only for the sake of explaining various embodiments consistent with the present disclosure. For example, it is also possible for all of the device types to be the same (e.g. smart phones).

In system 100, presentation device 106 may be to at least present multimedia content. Presenting multimedia content may include, for example, generating sound and/or displaying text, images, video, etc. streamed from remote resources 110. Given that presentation device 106 is a mobile handset like a smart phone, a communication-enabled computing device. etc. it may be able to stream multimedia content directly from remote resources 110 without any assistance from other devices. A real-world example of this type of operation may include streaming high-definition (HD) multimedia content to a wireless-enabled device (e.g., smart phone or tablet computer) using a long-range cellular network. While ideally this operation would allow users to enjoy high quality multimedia content everywhere, the communication speed and bandwidth currently available in wireless-enabled devices may not be sufficient to present HD multimedia content with acceptable quality, especially when presentation device 106 may have other communication/processing operations proceeding in the background.

In accordance with at least one embodiment, trusted devices 102 may be engaged by presentation device 106 to collaborate in the streaming of multimedia content from remote resources 110. For example, at least one trusted device 102 may be assigned to obtain a portion of the multimedia content, reducing the overall communication burden for each collaborating device. The portions of multimedia content that are obtained may be provided to leader 104, which may consolidate the various portions prior to providing the multimedia content to presenting device 106. If presenting device 106 is leader 104, then it may perform both the consolidation and presentation operations. In one embodiment, leader 104 may also be responsible for assigning responsibility to trusted devices 102 for downloading portions of the multimedia content. For example, leader 104 may evaluate the condition of each trusted device 102 (e.g., communication capability such as connection speed and bandwidth, power level, processing load, etc.) and may assign portions of the multimedia content to download to each trusted device 102 based on the device condition. Trusted devices 102 that have more capability/resources available may be assigned more content to download. System 100 may also be reconfigured on a real-time basis. For example, if presentation device 106 runs low on resources, then one of trusted devices 102 may be selected to the presentation device 106. Similarly, if leader 104 or trusted devices 102 become too busy, low on resources, etc., then a new leader 104 may be selected, portions of the multimedia content may be reassigned, etc.

In one embodiment, the multimedia content may be provided by remote resources 110 in encrypted format to protect the content from being viewed without permission, copied, etc. Different categories of licenses may then be available to grant various levels of access to the multimedia content based on, for example, device responsibilities. The licenses may be used by trusted devices 102, leader 104 and presentation device 106 to obtain encryption keys for use during collaborative streaming. The provisioning of a particular type of encryption key may depend on whether a user/device is subscribed to the content provider to consume (e.g., listen to and/or view) multimedia content. For example, a presentation content encryption key may be obtained by presentation device 106 after authentication by remote resources 110. The presentation content encryption key allows presentation device 106 to at least decrypt and present (e.g., and possibly download) encrypted multimedia content. However, trusted devices 102 (including leader 104 if selected from trusted devices 102) may be provided with download content encryption keys by remote resources 110. Download content encryption keys allow for download without the ability to decrypt the encrypted multimedia content, and thus, the encrypted multimedia content cannot be presented on devices with only a download content encryption key (e.g., trusted devices 102). In this manner, trusted devices 102 (and leader 104) may be limited to operating in a pass-through mode wherein the portions of the encrypted multimedia content are downloaded and maintained in encrypted form while being passed through to leader 104 (e.g., without modification). The use of different license/key types allow content providers to have greater control over how their content may be consumed, and thus, may encourage the content provider to make more content available for streaming. Moreover, having only one device (e.g., presentation device 106) subscribed to consume multimedia content from a content provider service does not prevent the use of collaborative streaming because trusted devices 102 (and leader 104) may operate in a pass-through mode, ensuring that only subscribed devices will be able to consume the content.

In one embodiment, it may be possible for presentation device 106 to obtain all of the encrypted multimedia content through trusted devices 102 without any direct interaction with remote resources 110. For example, at a least a processing module in presentation device 106 may be able to determine presentation device condition (e.g., communication status, power level, etc.) and may cause presentation device 106 to obtain the encrypted multimedia content exclusively via trusted devices 102. This mode of operation might occur in a situation where presentation device 106 is capable of presenting the encrypted multimedia content but does not currently have the ability to interact directly with remote resources 110 (e.g., a tablet computer that is not within range of a wired connection or short-range wireless access point). Alternatively, direct interaction between presentation device 106 and remote resources 100 may be available, but may be undesirable due to performance issues (e.g., speed/bandwidth limitations), higher cost, not enough power being available in presentation device 106 to operate a long-range wireless transceiver, etc. Presentation device 106 may include the necessary encryption keys for decrypting the encrypted multimedia content that it may obtain from trusted devices 102 in LAN 108. In this manner, presentation device 106 may obtain the encrypted multimedia content using higher bandwidth short-range communication having lower latency, power consumption, etc.

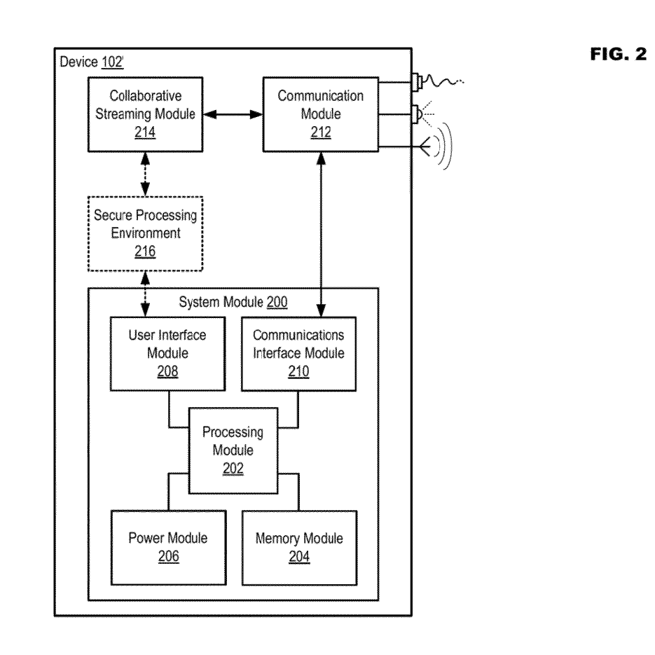

FIG. 2 illustrates an example configuration for a trusted device usable in accordance with at least one embodiment of the present disclosure. Since trusted device 102, leader 104 and presentation device 106 may all be the same type of device, trusted device 102′ may support functionality such as described in regard to any of the devices disclosed in FIG. 1. However, it is important to note that trusted device 102′ is meant only as an example of equipment that may be used in accordance with embodiments consistent with the present disclosure, and is not meant to limit these various embodiments to any particular manner of implementation.

Trusted device 102′ may comprise system module 200 configured to manage device operations. System module 200 may include, for example, processing module 202, memory module 204, power module 206, user interface module 208 and communication interface module 210 that may be configured to interact with communication module 212. Trusted device 102′ may further include collaborative streaming module 214 that may be configured to interact with at least communication module 212, and optionally, may also include secure processing environment 216 that may be configured to interact with at least collaborative streaming module 214 and user interface module 208. While communication module 212, collaborative streaming module 214 and secure processing environment 216 have been shown separately from system module 200 in FIG. 2, this example implementation of trusted device 102′ is merely for the sake of explanation herein. Some or all of the functionality associated with communication module 212, collaborative streaming module 214 and/or secure processing environment 104 may also be incorporated within system module 200).

In trusted device 102′, processing module 202 may comprise one or more processors situated in separate components, or alternatively, may comprise one or more processing cores embodied in a single component (e.g. in a System-on-a-Chip (SoC) configuration) and any processor-related support circuitry (e.g., bridging interfaces, etc.). Example processors may include, but are not limited to, various x86-based microprocessors available from the Intel Corporation including those in the Pentium, Xeon, Itanium, Celeron, Atom, Core i-series product families, Advanced RISC (e.g., Reduced Instruction Set Computing) Machine or “ARM” processors, etc. Examples of support circuitry may include chipsets (e.g., Northbridge, Southbridge, etc. available from the Intel Corporation) configured to provide an interface through which processing module 202 may interact with other system components that may be operating at different speeds, on different buses, etc. in trusted device 102′. Some or all of the functionality commonly associated with the support circuitry may also be included in the same physical package as the processor (e.g., such as the Sandy Bridge integrated circuit available from the Intel Corporation).

Processing module 202 may be configured to execute various instructions in trusted device 102′. Instructions may include program code configured to cause processing module 202 to perform activities related to reading data, writing data, processing data, formulating data, converting data, transforming data, etc. Information (e.g., instructions, data, etc.) may be stored in memory module 204. Memory module 204 may comprise random access memory (RAM) or read-only memory (ROM) in a fixed or removable format. RAM may include memory configured to hold information during the operation of trusted device 102′ such as, for example, static RAM (SRAM) or Dynamic RAM (DRAM). ROM may include memories such as bios or Unified Extensible Firmware Interface (UEFI) memory configured to provide instructions when trusted device 102′ activates, programmable memories such as electronic programmable ROMs (EPROMS). Flash, etc. Other fixed and/or removable memory may include magnetic memories such as, for example, floppy disks, hard drives, etc., electronic memories such as solid state flash memory (e.g., embedded multimedia card (eMMC), etc.), removable memory cards or sticks (e.g., micro storage device (aSD), USB, etc.), optical memories such as compact disc-based ROM (CD-ROM), etc. Power module 206 may include internal power sources (e.g. a battery) and/or external power sources (e.g., electromechanical or solar generator, power grid, fuel cell, etc.), and related circuitry configured to supply trusted device 102′ with the power needed to operate.

User interface module 208 may include equipment and software configured to allow users to interact with trusted device 102′ such as, for example, various input mechanisms (e.g., microphones, switches, buttons, knobs, keyboards, speakers, touch-sensitive surfaces one or more sensors configured to capture images and/or sense proximity, distance, motion, gestures, orientation, etc.) and output mechanisms (e.g. speakers, displays, lighted/flashing indicators, electromechanical components for vibration, motion, etc.). Communication interface module 210 may be configured to handle packet routing and other control functions for communication module 212, which may include resources configured to support wired and/or wireless communications. Wired communications may include serial and parallel wired mediums such as, for example, Ethernet, Universal Serial Bus (USB), Firewire, Digital Video Interface (DVI). High-Definition Multimedia Interface (HDMI), etc. Wireless communications may include, for example, close-proximity wireless mediums (e.g., radio frequency (RF) such as based on the Near Field Communications (NFC) standard, infrared (IR), optical character recognition (OCR), magnetic character sensing, etc.), short-range wireless mediums (e.g. Bluetooth, WLAN, Wi-Fi, etc.) and long range wireless mediums (e.g., cellular wide-area radio communication technology that may include, for example, a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology (e.g. UMTS (Universal Mobile Telecommunications System), FOMA (Freedom of Multimedia Access), 3GPP LTE (Long Term Evolution), 3GPP LTE Advanced (Long Term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+(High Speed Packet Access Plus), UMTS-TDD (Universal Mobile Telecommunications System—Time-Division Duplex), TD-CDMA (Time Division—Code Division Multiple Access), TD-CDMA (Time Division—Synchronous Code Division Multiple Access), 3GPP Rel. 8 (Pre-4G) (3rd Generation Partnership Project Release 8 (Pre-4th Generation)), 3GPP Rel. 9 (3rd Generation Partnership Project Release 9), 3GPP Rel. 10 (3rd Generation Partnership Project Release 10). 3GPP Rel. 11 (3rd Generation Partnership Project Release 11), 3GPP Rel. 12 (3rd Generation Partnership Project Release 12). UTRA (UMTS Terrestrial Radio Access). E-UTRA (Evolved UMTS Terrestrial Radio Access). LTE Advanced (4G) (Long Term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (LG) (Advanced Mobile Phone System (1st Generation)), TACS/ETACS (Total Access Communication System/Extended Total Access Communication System), D-AMPS (2G) (Digital AMPS (2nd Generation)), PIT (Push-to-talk), MTS (Mobile Telephone System), IMTS (Improved Mobile Telephone System), AMTS (Advanced Mobile Telephone System), OLT (Norwegian for Offentlig Landmobil Telefoni. Public Land Mobile Telephony), MTD (Swedish abbreviation for Mobiltelefonisystem D, or Mobile telephony system D). Autotel/PALM (Public Automated Land Mobile), ARP (Finnish for Autoradiopuhelin, “car radio phone”). NMT (Nordic Mobile Telephony). Hicap (High capacity version of NTT (Nippon Telegraph and Telephone)), CDPD (Cellular Digital Packet Data), Mobitex. DataTAC, iDEN (Integrated Digital Enhanced Network), PDC (Personal Digital Cellular), CSD (Circuit Switched Data), PHS (Personal Handy-phone System), WIDEN (Wideband Integrated Digital Enhanced Network), iBurst, Unlicensed Mobile Access (UMA, also referred to as also referred to as 3GPP Generic Access Network, or GAN standard), satellite-based communications, etc. In one embodiment, communication interface module 210 may be configured to prevent wireless communications that are active in communication module 212 from interfering with each other. In performing this function, communication interface module 210 may schedule activities for communication module 212 based on, for example, the relative priority of messages awaiting transmission.

In the embodiment illustrated in FIG. 2, collaborative streaming module 214 may be configured to interact with at least communication module 212. For example, collaborative streaming module 214 may utilize communication module 212 to interact with other trusted devices 102 in LAN 108, to provide condition information and/or receive instructions from leader 104, to authenticate to remote resources 110 (e.g., to obtain a content encryption key), to download encrypted multimedia content from remote resources 110, to provide encrypted multimedia content to leader 104, etc. Moreover, if trusted device 102′ is selected as leader 104, collaborative streaming module 214 may utilize communication module 212 to manage collaborative streaming by interacting with trusted devices 102 (e.g., requesting condition information, assigning portions of encrypted multimedia information to download, etc.).

Optionally, trusted device 102′ may include secure processing environment 216. Secure processing environment 216 may be configured to interact with at least user interface module 208 and collaborative streaming module 212. Secure processing environment 216 may be optional in that it may only be required in presentation device 106 for decrypting encrypted multimedia information and in one embodiment for authenticating trusted devices 102 and to remote resources 110. Secure processing environment 216 may be based on, for example, implementations of trusted execution environment (TEE) technology including, for example, the Secure Enclave functionality developed by the Intel Corporation. For example, the identity of programs (e.g. a cryptographic hash measurement of each program's contents) may be signed and stored inside each program. When the programs are loaded, the processor verifies that the measurement of the program (e.g., as computed by the processor) is identical to the measurement previously embedded inside the program. The signature used to sign the embedded measurement is also verifiable because the processor is provided with a public key used to verify the signature at program load time. Malware cannot tamper with the program without also altering its measurement, and cannot spoof the signature because the signing key is secure with the program's author. In this manner, the resident software may not be read, written to or altered by any malware. Moreover, trusted device 102′ may comprise more than one secure processing environment 214. Having more than one secure processing environment 214 may allow vulnerable operations in trusted device 102′ to be kept separate, and thus, may provide additional security because one secure processing environment 104 becoming compromised (e.g., by malware) may still leave the security of the remaining secure processing environments 104 intact and protected.

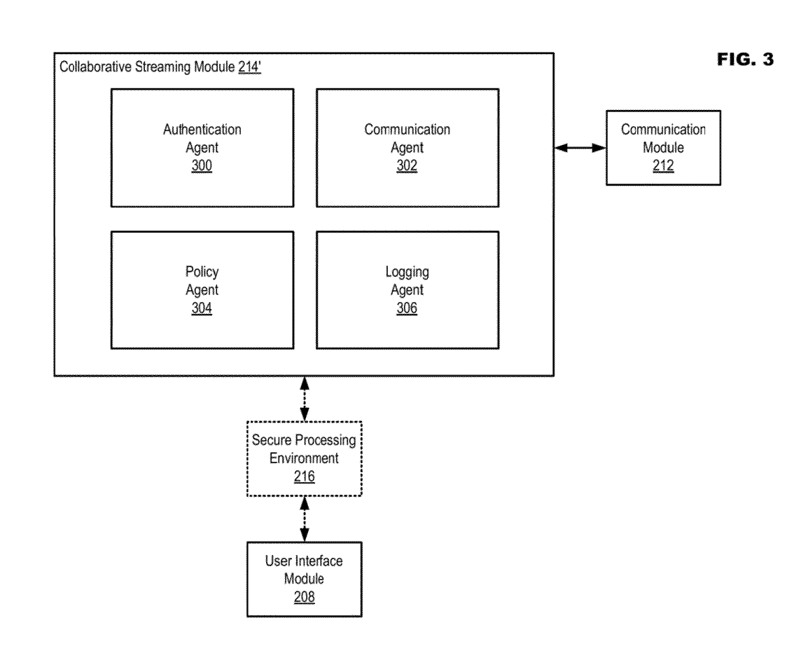

FIG. 3 illustrates an example configuration for a collaborative streaming module in accordance with at least one embodiment of the present disclosure. Collaborative streaming module 214′ may comprise, for example, authentication agent 300, communication agent 302 policy agent 304 and logging agent 306. Authentication agent 300 may be configured to authenticate trusted device 102′ with other trusted devices 102′ (e.g., including presentation device 106) and with remote resources 110. In one embodiment authentication agent 300 may cooperate with secure processing environment 216 to decrypt encrypted information, to securely store content encryption keys, etc. Communication agent 302 may be configured to control secure communications between trusted devices 102, leader 104, presentation device 106 and remote resources 110 related to collaborative streaming. Policy agent 304 may be configured to manage policy information and storage/retrieval from secure storage in trusted device 102′. Policy information may include rules specifying to what extent trusted device 102′ is allowed to interact in LAN 108, how various resources in trusted device 102′ (e.g. processing, power, memory, etc.) are allowed to be expended for collaborative streaming, etc. The rules in policy agent 304 may be predetermined, set by leader 104 and/or presentation device 106, configured by a device user, etc. Logging agent 306 may be configured to log some or all transactions related to collaborative streaming (e.g., based on user configuration).

In an example of operation, trusted device 102′ may determine that collaborative streaming is being activated. The activation of collaborative streaming may be prompted by activities such as, for example, the manual activation of a collaborative streaming application in trusted device 102′, upon triggering an application for streaming multimedia content from remote resources 110, upon receiving a request from presentation device 106 to participate in collaborative streaming via wired or wireless communication, etc. Authentication agent 300 may then interact with other trusted devices 102′ and remote resources 110 to join LAN 108 and obtain a content encryption key. After collaborative streaming has been configured and initiated (e.g. leader 104 has been selected, device condition information has been collected, download responsibility has been assigned based on the device condition information, etc.), communication agent 302 may manage device operation in regard to collaborative streaming within the operational guidelines set in policy agent 304 (e.g., within processing limits, while device power remains above a certain level, etc.). Logging agent 306 may then proceed to log information such as, for example, session information, time and usage statistics, etc.

In one embodiment, communication agent 302 in presentation device 106 may receive encrypted multimedia content from leader 104 (e.g., selected from a group of trusted devices 102), or if presentation device 106 is selected as leader 104, then communication agent 104 may receive portions of the encrypted multimedia directly from the group of trusted devices 102. In either instance, communication agent 302 may then route the encrypted multimedia content to secure processing environment 216 for decryption. Secure processing environment 216 may include at least a presentation content encryption key for decrypting the encrypted multimedia content. In one embodiment the decrypted multimedia content may be provided to user interface module 208 for presentation. Alternatively, secure processing environment 216 may protect the decrypted multimedia content from being intercepted, copied, altered, etc. by any malware in presentation device 106 through the use of one or more encryption protocols local to presentation device 106. For example, the Protected Audio Video Path (PAVP) and High-Bandwidth Digital Content Protection (HDCP) Protocols developed by the Intel Corporation may be used to protect the multimedia content. PAVP may be configured to protect multimedia content when being conveyed between initial processing including, for example, audio and/or video compression/decompression (codec) and dedicated audio/video processing resources (e.g., coprocessors, audio/video chipsets or cards, etc.) in presentation device 106. Likewise, HDCP may be configured to protect multimedia content when being conveyed between the audio/video processing resources and user interface equipment (e.g., speakers, headphones, displays, etc.). In this manner, the multimedia content may remain 30 protected by some form of encryption until ultimately presented by presentation device 106.

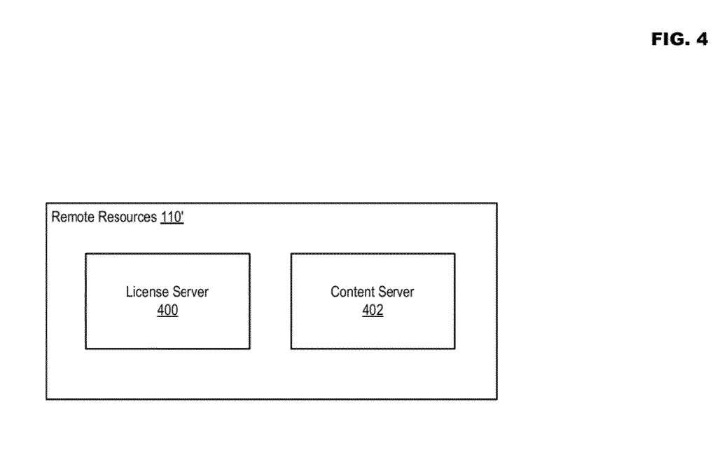

FIG. 4 illustrates an example configuration for remote resources in accordance with at least one embodiment of the present disclosure. In one embodiment, remote resources 110′ may be a cloud entity, wherein one or more servers contain programmatic constructs (e.g., applications, databases, etc.) accessible via a wide-area network (WAN) like the Internet. For example, remote resources 110′ may comprise, for example, at least license server 400 and content server 402. License server 400 may be configured to authenticate trusted devices 102′, leader 104 and presentation device 106. Authentication may include, for example, determining if a user/device is permitted to participate in collaborative streaming based on user identification (ID), device ID, licenses, etc. Licenses may be provisioned during device manufacturing, during configuration by a vendor for a user, etc. Licenses may define a type or group of trusted devices 102 that are allowed to participate in collaborative streaming. For example, certain content providers may permit devices from certain vendors (e.g., wireless providers) to participate in collaborative streaming, and then only certain devices from the group of trusted device 102 may be allowed to present content (e.g., customers of the wireless providers may subscribe to an extra service that allows multimedia content to be streamed). Based on the authentication, licensing server 400 may provide a content encryption key for use in collaborative streaming. In one embodiment, the content encryption key may be a presentation content encryption key or a download content encryption key. Content server 402 may then be configured to provide multimedia content (e.g., music, movies, seminars, concerts, television shows, textual information, etc.) to the group of trusted devices 102.

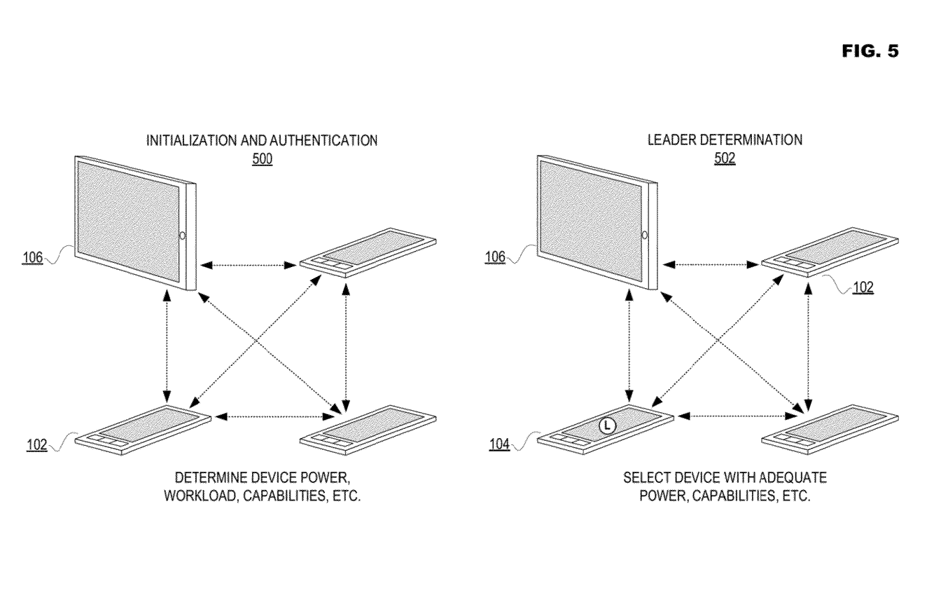

FIG. 5 illustrates an example of leader selection in accordance with at least one embodiment of the present disclosure. In one embodiment, the formation of a group of trusted devices 102 may be orchestrated by presentation device 106. Presentation device 106 may be responsible for instigating group formation because it is on presentation device 106 that streaming may be activated manually (e.g., by user configuration) or automatically (e.g. by an application for streaming multimedia content). Presentation device 106 may then scan for trusted devices 102 via wired communication (e.g., Ethernet) and/or short-range wireless communication (e.g. Bluetooth, WLAN) as shown at 500. After trusted devices 102 are located and authenticated (e.g., based on user ID, device ID, licenses, etc.), a wired and/or wireless short-range wireless network may be formed including all authenticated trusted devices 102 and presentation device 106. In one embodiment, presentation device 106 may then determine a device condition for all trusted devices 102. Device condition may include, for example, processing/communication capabilities, power level, processing load, etc. A leader determination may then be made as shown at 502 wherein a trusted device 102 or presentation device 106 may be selected as leader 104. Leader 104 may be the device with a combination of good processing/communication capability and resource availability. Strong capability and resource availability is needed because leader 104 may manage collaborative streaming while also consolidating portions of encrypted multimedia content for presentation.

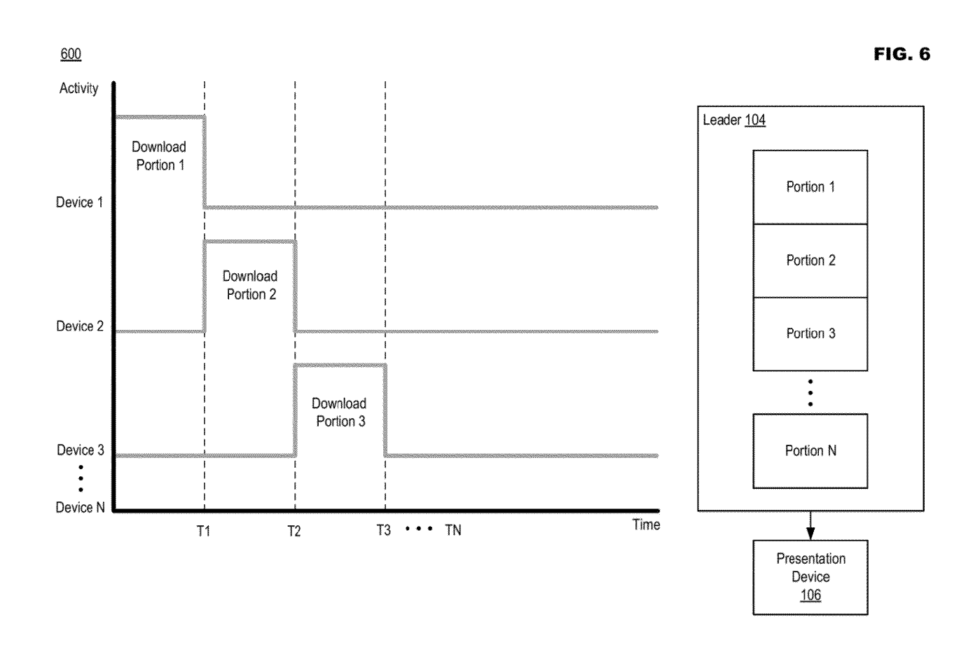

FIG. 6 illustrates an example of assigning devices to download content sequentially in accordance with at least one embodiment of the present disclosure. Collaborative streaming may be executed by a group of trusted devices 102 wherein one or more of trusted devices 102 may be configured to download portions of encrypted multimedia content from remote resources 110. However, the manner in which the encrypted multimedia content is obtained may vary depending on, for example, the condition of trusted devices 102. An example flow diagram wherein full portions are downloaded sequentially is illustrated at 600. For example, device 1 may download portion 1 at time 1 (T1) followed by device 2 downloading portion 2 at T2, device 3 downloading portion 3 at T3 for a total of number of N trusted devices 102 in the group of trusted devices 102. After each device 1 to N downloads a portion, it may start to download another sequential portion and the sequence may repeat as long as there is more encrypted multimedia content to download. Portions 1 to N may be provided to leader 104, which may consolidate portions 1 to N prior to making them available to presentation device 106. One advantage of sequential download is that higher performance may realized by fully leveraging the processing/communication capabilities of devices 1 to N. However, sequential download 600 may not be possible when devices 1 to N may be busy with other tasks, and as a result, the processing/communication resources of device 1 to N are otherwise employed. It is important to note that while FIG. 6 shows a separate leader 104, presentation device 106 may be selected as leader 104, and in that regard would also handle the duties of leader 104.

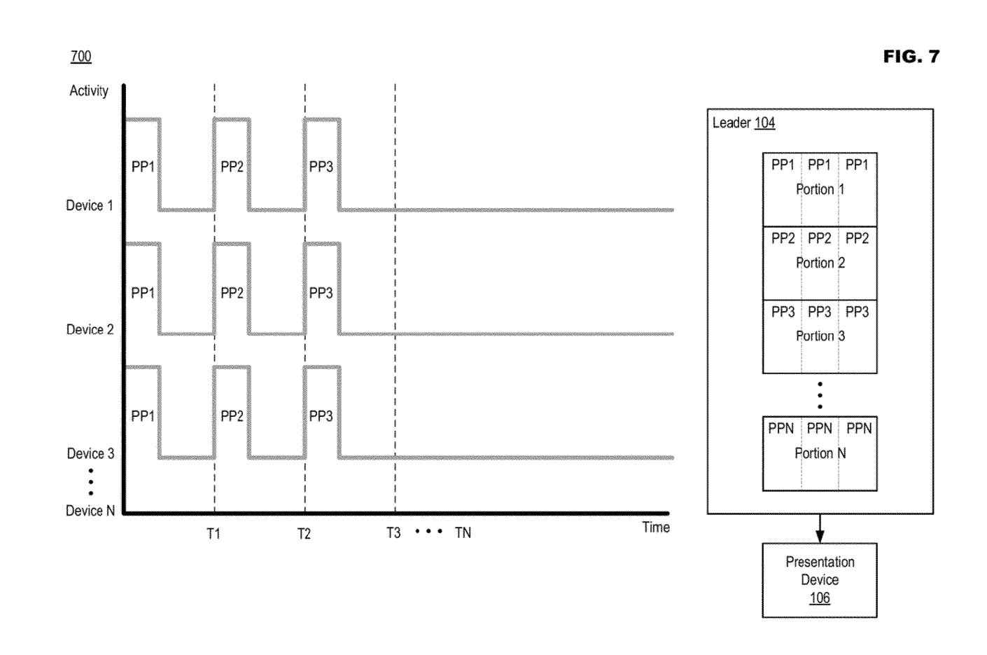

FIG. 7 illustrates an example of assigning devices to download content concurrently in accordance with at least one embodiment of the present disclosure. Concurrent download 700 breaks portions 1 to N down into partial portions (PP) PP1 to PPN. For example, devices 1 to N may each download a small PP of portion 1. The amount of data in PP1 may be based on, for example, the total number of devices 1 to N. The more devices in the group of trusted devices 102, the smaller the PP may be. After the download of PP1 is complete, PP2 may be downloaded followed by PP3 and so on as long as there is encrypted multimedia content to download. The PP of each portion 1 to N may then be provided to leader 104, which may consolidate the PP into portions 1 to N, and the portions 1 to N into the encrypted multimedia content which may then be provided to presentation device 106. Concurrent download 700 may be beneficial where trusted devices 102 are busy with other tasks, are low on power, etc., and thus, do not have a substantial amount of resources to devote to collaborative streaming. Trusted devices 102 are requested to download a smaller amount of data each period, which may reduce the instantaneous communication burden. However, concurrent download 700 may download data at a slower rate and/or may create more pieces of encrypted multimedia content for leader 104 to assemble, and thus, may deliver slightly slower performance when compared to sequential download 600 when using the same number of trusted devices 102. Adding more trusted devices 102 may help boost performance for concurrent download 700. It is important to note that while FIG. 7 shows a separate leader 104, presentation device 106 may be selected as leader 104, and in that regard would also handle the duties of leader 104. The decision to operate using sequential download 600 or concurrent download 700 may be, for example, configured automatically by leader 104 (e.g., depending on the condition each trusted device 102) configured manually in policy agent 304 via user interface module 208, etc.

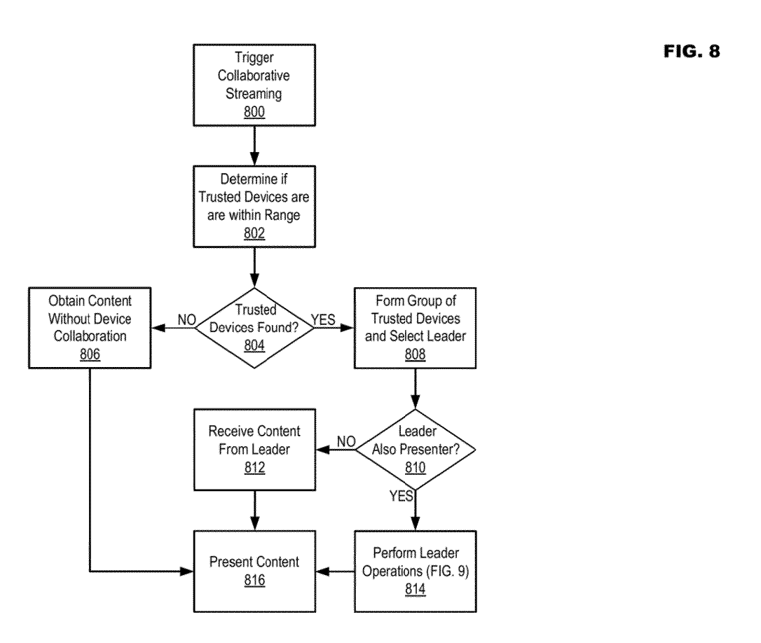

FIG. 8 illustrates example operations from the perspective of a presentation device in accordance with at least one embodiment of the present disclosure. Initially, an activity in a presentation device may trigger collaborative streaming in operation 800. For example, a collaborative streaming application may be activated, an application capable of streaming multimedia content from remote resources may be activated that may, in turn, trigger the activation of collaborative streaming, based on a determined condition (e.g., communication status, power level, etc.) of the presentation device, etc. In operation 802 the presentation device may then determine if any trusted devices are in communication range. For example, the presentation device may begin scanning via wired and/or short-range wireless communication for other devices, and may then attempt to authenticate any encountered devices. In operation 804 a determination may be made as to whether any trusted devices were located and authenticated. If in operation 804 it is determined that no trusted devices were found, then in operation 806 the presentation device may obtain multimedia content without collaborative streaming (e.g. directly from the remote resources). In operation 816 the multimedia content may then be presented by the presentation device (e.g. sound may be generated and/or text, images or video may be displayed based on the multimedia content).

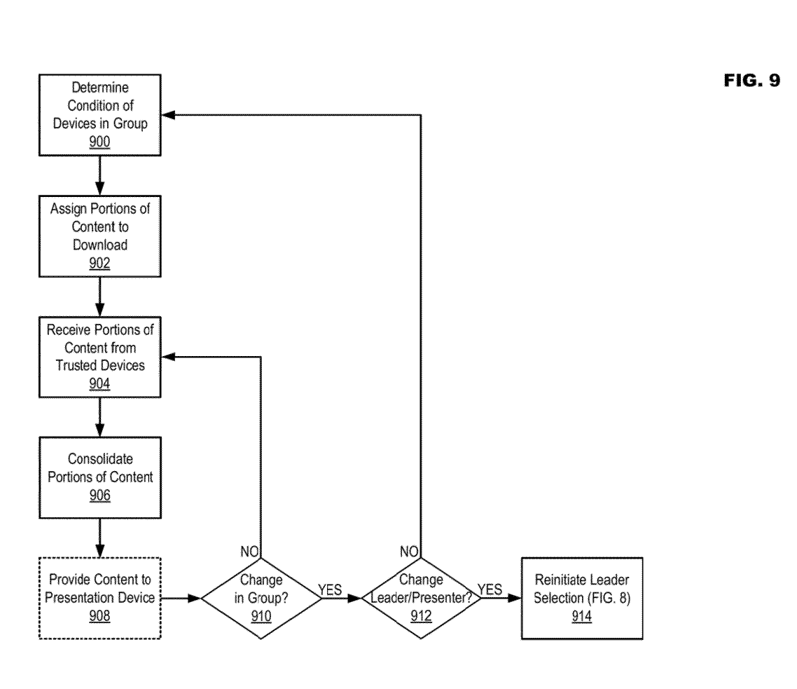

If in operation 804 it is determined that trusted devices are in communication range of the presentation device, then in operation 808 a group of trusted devices may be formed (e.g., as a LAN including the presentation device and trusted devices), and a leader of the group of trusted devices may be selected from amongst the presentation device and the trusted devices. In operation 810 a determination may be made as to whether the presentation device has been selected as the leader. If it is determined that the presentation device is not the leader, then in operation 812 the presentation device may receive multimedia content from the leader, which the presentation device may then present in operation 816. Alternatively, if in operation 810 it is determined that the presentation device is the leader, then the presentation device may also perform operations as the leader in operation 814 (e.g. as disclosed in more detail in FIG. 9) and may then proceed to present the multimedia content in operation 816.

FIG. 9 illustrates example operations from the perspective of a leader in accordance with at least one embodiment of the present disclosure. In operation 900 the leader may determine the condition of trusted devices in the group of trusted devices. The leader may then proceed to assign portions of the multimedia content to download to at least one trusted device in the group of trusted devices in operation 902. The assignment of portions of the multimedia content to download may be based on the previously determined condition of the trusted devices. In operation 904 the leader may receive portions of the multimedia content from the trusted devices, and may proceed to consolidate the received portions of multimedia content in operation 906. If the presentation device was not selected as the leader, then in optional operation 908 the leader may provide the consolidated multimedia content to the presentation device in operation 908.

A determination may then be made in operation 910 as to whether a change has occurred in the group of trusted devices. For example, one of the trusted devices may have moved out of range of the presentation device, may have experienced a change in condition with respect to power level, processor loading, etc. A determination in operation 910 that no change has occurred may be followed by a return to operation 904 to receive more portions of the multimedia content from the group of trusted devices. If in operation 910 it is determined that a change has occurred, then in operation 912 a further determination may be made as to whether the leader and/or presentation device has changed. A determination in operation 912 that the leader and/or presentation device has not change may be followed by a return to operation 900 to update the current condition of the trusted devices in the group of trusted devices. Otherwise, if in operation 912 it is determined that a change has occurred with the leader and/or presentation device, then in operation 914 the leader of the group of trusted devices may be reselected (e.g., such as set forth in the operations disclosed in FIG. 8)

While FIGS. 8 and 9 illustrate operations according to different embodiments, it is to be understood that not all of the operations depicted in FIGS. 8 and 9 are necessary for other embodiments. Indeed, it is fully contemplated herein that in other embodiments of the present disclosure, the operations depicted in FIGS. 8 and 9, and/or other operations described herein, may be combined in a manner not specifically shown in any of the drawings, but still fully consistent with the present disclosure. Thus, claims directed to features and/or operations that are not exactly shown in one drawing are deemed within the scope and content of the present disclosure.

As used in this application and in the claims, a list of items joined by the term “and/or” can mean any combination of the listed items. For example, the phrase “A. B and/or C” can mean A; B: C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C: or A, B and C.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage mediums. Firmware may be embodied as code, instructions or instruction sets and/or data that are hard-coded (e.g., nonvolatile) in memory devices. “Circuitry” as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smartphones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry. Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), embedded multimedia cards (eMMCs), secure digital input/output (SDIO) cards, magnetic or optical cards, or any type of media suitable for storing electronic instructions. Other embodiments may be implemented as software modules executed by a programmable control device.

Thus, the present disclosure is directed to a collaborative streaming system for protected media. A presentation device may interact with a group of trusted devices over a network to stream multimedia content. The presentation device may obtain a presentation content encryption key for presenting the content. Each trusted device in a group of trusted devices may obtain a download content encryption key allowing for download without presentation. A leader may be selected for managing the operation of the trusted devices. The leader may determine trusted device condition and assign one or more of the trusted devices to download portions of the content based on the condition. The leader may then consolidate the portions of the content and provide them to the presentation device. If the presentation device is the leader, the presentation device may perform similar operations and collect the portions of the content directly from the group of trusted devices.

The following examples pertain to further embodiments. The following examples of the present disclosure may comprise subject material such as a device, a method, at least one machine-readable medium for storing instructions that when executed cause a machine to perform acts based on the method, means for performing acts based on the method and/or a system for a collaborative streaming system for protected media, as provided below.

### Example 1

According to this example there is provided a presentation device. The presentation device may include a communication module to communicate via at least one of wired or wireless communication, a collaborative streaming module to receive encrypted multimedia content from at least one trusted device in a group of trusted devices via the communication module, a secure processing environment to receive the encrypted multimedia content from the collaborative streaming module and to decrypt the encrypted multimedia content based on a first encryption protocol and a user interface module to receive the decrypted multimedia content from the secure processing environment and to present the decrypted multimedia content.

### Example 2

This example includes the elements of example 1, and further comprises a presentation content encryption key allowing at least decryption of the encrypted multimedia content for presentation by the user interface module.

### Example 3

This example includes the elements of example 2, wherein the collaborative streaming module is further to obtain the presentation content key by authenticating to remote resources.

### Example 4

This example includes the elements of example 3, wherein trusted devices in the group of trusted devices each comprise a download content encryption key permitting download of the encrypted multimedia content without the ability to decrypt the encrypted multimedia content, the trusted devices obtaining the download encryption key by authenticating to the remote resources.

### Example 5

This example includes the elements of any of examples 2 to 3, wherein the remote resources comprise at least a multimedia content server and a license server.

### Example 6

This example includes the elements of any of examples 2 to 3, wherein authenticating to the remote resources is based on licenses provisioned to at least one of the presentation device or the trusted devices during manufacturing or configuration by a vendor for use by an end user.

### Example 7

This example includes the elements of any of examples 1 to 6, wherein the collaborative streaming module is further to determine if trusted devices are in communication range of the presentation device, form the group of trusted devices from the trusted devices determined to be in communication range and select a leader for the group of trusted devices.

### Example 8

This example includes the elements of example 7, wherein forming the group of trusted devices comprises establishing a network including at least the presentation device and trusted devices in communication range of the presentation device based on at least one of wired communication or short-range range wireless communication.

### Example 9

This example includes the elements of any of examples 7 to 8, wherein if a trusted device in the group of trusted devices is selected to be the leader, the collaborative streaming module is to receive the encrypted multimedia content from the trusted device selected as leader.

### Example 10

This example includes the elements of example 9, wherein the leader is to receive portions of the encrypted multimedia content from at least one other trusted device in the group of trusted devices, consolidate the received portions of encrypted multimedia content; and provide the encrypted multimedia content to the presentation device.

### Example 11

This example includes the elements of any of examples 7 to 10, wherein if the presentation device is selected as the leader, the collaborative streaming module is further to receive portions of the encrypted multimedia content from at least one trusted device in the group of trusted devices.

### Example 12

This example includes the elements of example 11, wherein the collaborative streaming module is further to determine a device condition for each trusted device in the group of trusted devices.

### Example 13

This example includes the elements of example 12, wherein the collaborative streaming module is further to assign the portions of the encrypted multimedia content for download to at least one trusted device in the group of trusted devices based on the device condition for each trusted device.

### Example 14

This example includes the elements of example 13, wherein the collaborative streaming module is further to determine changes in device condition for any of the trusted devices and reassign the portions of the encrypted multimedia content for download based on the device condition changes.

### Example 15

This example includes the elements of any of examples 11 to 14, wherein the portions of the encrypted multimedia content are received sequentially from the group of trusted devices.

### Example 16

This example includes the elements of any of examples 11 to 14, wherein the portions of the encrypted multimedia content are received concurrently from the group of trusted devices.

### Example 17

This example includes the elements of any of examples 1 to 16, wherein the secure processing environment is to encrypt the decrypted multimedia content based on a second encryption protocol and the user interface module is to decrypt the encrypted multimedia content based on the second encryption protocol prior to presenting the decrypted multimedia content.

### Example 18

This example includes the elements of example 17, wherein the second encryption protocol is based on Protected Audio Video Path (PAVP) protocol.

### Example 19

This example includes the elements of any of examples 1 to 18, further comprising at least a processing module to determine presentation device condition including at least one of communication status and power level, the processing module being further to cause the collaborative streaming module to receive the encrypted multimedia content from the at least one trusted device in the group of trusted devices based on the determined presentation device condition.

### Example 20

This example includes the elements of example 1, wherein the collaborative streaming module is further to determine if trusted devices are in communication range of the presentation device, form the group of trusted devices from the trusted devices determined to be in communication range and select a leader for the group of trusted devices.

### Example 21

This example includes the elements of example 20, wherein if a trusted device in the group of trusted devices is selected to be the leader, the collaborative streaming module is to receive the encrypted multimedia content from the trusted device selected as leader, the leader being to receive portions of the encrypted multimedia content from at least one other trusted device in the group of trusted devices, consolidate the received portions of encrypted multimedia content and provide the encrypted multimedia content to the presentation device.

### Example 22

This example includes the elements of example 21, wherein if the presentation device is selected as the leader, the collaborative streaming module is further to determine a device condition for each trusted device in the group of trusted devices, assign the portions of the encrypted multimedia content for download to at least one trusted device in the group of trusted devices based on the device condition for each trusted device and receive portions of the encrypted multimedia content from at least one trusted device in the group of trusted devices.

### Example 23

This example includes the elements of example 22, wherein the collaborative streaming module is further to determine changes in device condition for any of the trusted devices and reassign the portions of the encrypted multimedia content for download based on the device condition changes.

### Example 24

This example includes the elements of any of examples 1 to 23, wherein the presentation device is a mobile communication device.

### Example 25

This example includes the elements of any of examples 1 to 23, wherein the presentation device is a mobile computing device.

### Example 26

This example includes the elements of any of examples 1 to 23, wherein the presentation device is a stationary computing device.

### Example 27

According to this example there is provided a method. The method may include determining if trusted devices are in communication range of a presentation device, if at least one trusted device is determined to be in communication range, forming a group of trusted devices, selecting a leader of the group of trusted devices, receiving encrypted multimedia content from at least one trusted device in the group of trusted devices, decrypting the encrypted multimedia content based on a first encryption protocol and presenting the decrypted multimedia content.

### Example 28

This example includes the elements of example 27, further comprising obtaining a presentation encryption key from remote resources, the presentation encryption key allowing at least decryption of the encrypted multimedia content prior to presentation.

### Example 29

This example includes the elements of example 28, wherein obtaining the presentation encryption key from the remote resources comprises authenticating to the remote resources based on licenses provisioned to the presentation device during manufacturing or configuration by a vendor for use by an end user.

### Example 30

This example includes the elements of any of examples 28 to 29, wherein the remote resources comprise at least a multimedia content server and a license server.

### Example 31

This example includes the elements of any of examples 28 to 30, wherein if it is determined that there are no trusted devices in communication range, the encrypted multimedia content is obtained directly from the remote resources.

### Example 32

This example includes the elements of any of examples 28 to 31, wherein forming a group of trusted devices comprises establishing a network including at least the presentation device and trusted devices determined to be in communication range of the presentation based on at least one of wired communication or short-range range wireless communication.

### Example 33

This example includes the elements of any of examples 28 to 32, wherein if a trusted device in the group of trusted devices is selected as leader, the encrypted multimedia content is received from the leader.

### Example 34

This example includes the elements of any of examples 28 to 33, wherein if the presentation device is selected as leader, receiving the encrypted content comprises receiving portions of the encrypted content from at least one trusted device in the group of trusted devices.

### Example 35

This example includes the elements of example 34, further comprising determining a device condition for each trusted device in the group of trusted devices and assigning the portions of the encrypted multimedia content for download to at least one trusted device in the group of trusted devices based on the device condition for each trusted device.

### Example 36

This example includes the elements of example 35, further comprising determining changes in device condition for any of the trusted devices and reassigning the portions of the encrypted multimedia content for download based on the device condition changes.

### Example 37

This example includes the elements of any of examples 34 to 36, wherein receiving the encrypted multimedia content comprises receiving portions of the encrypted multimedia content sequentially from the group of trusted devices.

### Example 38

This example includes the elements of any of examples 34 to 36, wherein receiving the encrypted multimedia content comprises receiving portions of the encrypted multimedia content concurrently from the group of trusted devices.

### Example 39

This example includes the elements of any of examples 27 to 38, further comprising encrypting the decrypted multimedia content based on a second encryption protocol and decrypting the encrypted multimedia content based on the second encryption protocol prior to presenting the decrypted multimedia content.

### Example 40

This example includes the elements of example 39, wherein the second encryption protocol is based on Protected Audio Video Path (PAVP) protocol.

### Example 41

This example includes the elements of any of examples 27-40, further comprising determining presentation device condition including at least one of communication status and power level and causing the determination if trusted devices are in communication range of a presentation device based on the determined presentation device condition.

### Example 42

This example includes the elements of example 28, wherein if the presentation device is selected as leader determining a device condition for each trusted device in the group of trusted devices, assigning the portions of the encrypted multimedia content for download to at least one trusted device in the group of trusted devices based on the device condition for each trusted device and receiving the encrypted content comprises receiving portions of the encrypted content from at least one trusted device in the group of trusted devices.

### Example 43

This example includes the elements of example 42, further comprising determining changes in device condition for any of the trusted devices and reassigning the portions of the encrypted multimedia content for download based on the device condition changes.

### Example 44

This example includes a system comprising at least a presentation device and a group of trusted devices, the system being arranged to perform the method of any of the above examples 28 to 43.

### Example 45

This example includes a chipset arranged to perform the method of any of the above examples 28 to 43.

### Example 46

This example includes at least one machine readable medium comprising a plurality of instructions that in response to be being executed on a computing device, cause the computing device to carry out the method of any of the above examples 28 to 43.

### Example 47

This example includes at least one machine-readable storage medium having stored thereon, individually or in combination, instructions that when executed by one or more processors result in operations to perform the method of any of the above examples 28 to 43.

### Example 48

This example includes a device configured for use with a collaborative streaming system for protected media, the device being arranged to perform the method of any of the above examples 28 to 43.

### Example 49

This example includes a device having means to perform the method of any of the above examples 28 to 43.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

1-28. (canceled)

29. A presentation device, comprising:
a communication module to communicate via at least one of wired or wireless communication;
a collaborative streaming module to receive encrypted multimedia content from at least one trusted device in a group of trusted devices via the communication module;
a secure processing environment to receive the encrypted multimedia content from the collaborative streaming module and to decrypt the encrypted multimedia content based on a first encryption protocol; and
a user interface module to receive the decrypted multimedia content from the secure processing environment and to present the decrypted multimedia content.

30. The presentation device of claim 29, further comprising a presentation content encryption key allowing at least decryption of the encrypted multimedia content for presentation by the user interface module.

31. The presentation device of claim 30, wherein the collaborative streaming module is further to obtain the presentation content key by authenticating to remote resources.

32. The presentation device of claim 31, wherein trusted devices in the group of trusted devices each comprise a download content encryption key permitting download of the encrypted multimedia content without the ability to decrypt the encrypted multimedia content, the trusted devices obtaining the download encryption key by authenticating to the remote resources.

33. The presentation device of claim 29, wherein the collaborative streaming module is further to:
determine if trusted devices are in communication range of the presentation device;
form the group of trusted devices from the trusted devices determined to be in communication range; and
select a leader for the group of trusted devices.

34. The presentation device of claim 33, wherein if a trusted device in the group of trusted devices is selected to be the leader, the collaborative streaming module is to receive the encrypted multimedia content from the trusted device selected as leader, the leader being to:
receive portions of the encrypted multimedia content from at least one other trusted device in the group of trusted devices;
consolidate the received portions of encrypted multimedia content; and
provide the encrypted multimedia content to the presentation device.

35. The presentation device of claim 33, wherein if the presentation device is selected as the leader, the collaborative streaming module is further to:
determine a device condition for each trusted device in the group of trusted devices;
assign the portions of the encrypted multimedia content for download to at least one trusted device in the group of trusted devices based on the device condition for each trusted device; and
receive portions of the encrypted multimedia content from at least one trusted device in the group of trusted devices.

36. The presentation device of claim 35, wherein the collaborative streaming module is further to:
determine changes in device condition for any of the trusted devices; and
reassign the portions of the encrypted multimedia content for download based on the device condition changes.

37. The presentation device of claim 29, wherein the secure processing environment is to encrypt the decrypted multimedia content based on a second encryption protocol and the user interface module is to decrypt the encrypted multimedia content based on the second encryption protocol prior to presenting the decrypted multimedia content.

38. The presentation device of claim 29, further comprising at least a processing module to determine presentation device condition including at least one of communication status and power level, the processing module being further to cause the collaborative streaming module to receive the encrypted multimedia content from the at least one trusted device in the group of trusted devices based on the determined presentation device condition.

39. A method, comprising:
determining if trusted devices are in communication range of a presentation device;
if at least one trusted device is determined to be in communication range, forming a group of trusted devices;
selecting a leader of the group of trusted devices;
receiving encrypted multimedia content from at least one trusted device in the group of trusted devices;
decrypting the encrypted multimedia content based on a first encryption protocol; and
presenting the decrypted multimedia content.

40. The method of claim 39, further comprising:
obtaining a presentation encryption key from remote resources comprising at least a multimedia content server and a license server, the presentation encryption key allowing at least decryption of the encrypted multimedia content prior to presentation.

41. The method of claim 39, wherein if it is determined that there are no trusted devices in communication range, the encrypted multimedia content is obtained directly from the remote resources.

42. The method of claim 39, wherein if a trusted device in the group of trusted devices is selected as leader, the encrypted multimedia content is received from the leader.

43. The method of claim 39, wherein if the presentation device is selected as leader, receiving the encrypted content comprises:
determining a device condition for each trusted device in the group of trusted devices;
assigning the portions of the encrypted multimedia content for download to at least one trusted device in the group of trusted devices based on the device condition for each trusted device; and
receiving portions of the encrypted content from at least one trusted device in the group of trusted devices.

44. The method of claim 43, further comprising:
determining changes in device condition for any of the trusted devices; and
reassigning the portions of the encrypted multimedia content for download based on the device condition changes.

45. The method of claim 39, further comprising:
encrypting the decrypted multimedia content based on a second encryption protocol; and
decrypting the encrypted multimedia content based on the second encryption protocol prior to presenting the decrypted multimedia content.

46. The method of claim 39, further comprising:
determining presentation device condition including at least one of communication status and power level; and
causing the determination if trusted devices are in communication range of a presentation device based on the determined presentation device condition.

47. At least one machine-readable storage medium having stored thereon, individually or in combination, instructions that when executed by one or more processors result in the following operations comprising:
determining if trusted devices are in communication range of a presentation device;
if at least one trusted device is determined to be in communication range, forming a group of trusted devices;
selecting a leader of the group of trusted devices;
receiving encrypted multimedia content from at least one trusted device in the group of trusted devices;
decrypting the encrypted multimedia content based on a first encryption protocol; and
presenting the decrypted multimedia content.

48. The medium of claim 47, further comprising instructions that when executed by one or more processors result in the following operations comprising:
obtaining a presentation encryption key from remote resources comprising at least a multimedia content server and a license server, the presentation encryption key allowing at least decryption of the encrypted multimedia content prior to presentation.

49. The medium of claim 47, wherein if it is determined that there are no trusted devices in communication range, further comprising instructions that when executed by one or more processors result in obtaining the encrypted multimedia content directly from the remote resources.

50. The medium of claim 47, wherein if a trusted device in the group of trusted devices is selected as leader, further comprising instructions that when executed by one or more processors result in receiving the encrypted multimedia content from the leader.

51. The medium of claim 47, wherein if the presentation device is selected as leader, receiving the encrypted content comprises instructions that when executed by one or more processors result in the following operations comprising:
determining a device condition for each trusted device in the group of trusted devices;
assigning the portions of the encrypted multimedia content for download to at least one trusted device in the group of trusted devices based on the device condition for each trusted device; and
receiving portions of the encrypted content from at least one trusted device in the group of trusted devices.

52. The medium of claim 51, further comprising instructions that when executed by one or more processors result in the following operations comprising:
determining changes in device condition for any of the trusted devices; and
reassigning the portions of the encrypted multimedia content for download based on the device condition changes.

53. The method of claim 47, further comprising instructions that when executed by one or more processors result in the following operations comprising:
encrypting the decrypted multimedia content based on a second encryption protocol; and
decrypting the encrypted multimedia content based on the second encryption protocol prior to presenting the decrypted multimedia content.

54. The medium of claim 47, further comprising instructions that when executed by one or more processors result in the following operations comprising:
determining presentation device condition including at least one of communication status and power level; and
causing the determination if trusted devices are in communication range of a presentation device based on the determined presentation device condition.
